(19) United States
(12) Patent Application Publication
(10) Pub. No.: US 2008/0016519 A1
(43) Pub. Date: Jan. 17, 2008

(54) SCREEN TRANSITION PROGRAM GENERATING METHOD AND DEVICE

(75) Inventor: Yuko KOBAYASHI, Tokyo (JP)

Correspondence Address: SUGHRUE MION, PLLC, 2100 PENNSYLVANIA AVENUE, N.W., SUITE 800, WASHINGTON, DC, 20037, US

(73) Assignee: NEC CORPORATION, Tokyo (JP)

(21) Appl. No.: 11/734,666

(22) Filed: Apr. 12, 2007

(30) Foreign Application Priority Data
Apr. 19, 2006 (JP) 2006-115670

(51) Int. Cl. G06F 9/44

(52) U.S. Cl. 719/328

(57) ABSTRACT

A screen transition program generating device searches a processing program corresponding to an event in a screen defining file, which is source code to define the screen, when a user provides instructions to create an executable file for preview, and changes a processing program corresponding to the searched event into a runtime library calling program required for the transition between screens corresponding to the event by referencing screen transition information that defines relationship between the previously created event and the transition between screens. Then it generates the executable file for preview from the screen defining file including the runtime library calling program.

This application is based upon and claims the benefit of priority from Japanese Patent Application No. 2006-115670 filed on Apr. 19, 2006, the content of which is incorporated by reference.

### BACKGROUND OF THE INVENTION

1. Field of the Invention

The present invention relates to a screen transition program generating method and device for enabling an application program to be previewed on a screen.

2. Description of the Related Art

In recent information processing units, the GUI (Graphical User Interface) that enables data viewing and input operations to be visually shown on a screen is widely used for user interfaces. In view of this trend, various tools to support screen designing operations have been developed. As a kind of such designing supporting tool, a screen designing tool for arranging various controls (buttons, text boxes and the like) on a screen or a screen transition creating tool for transiting the screen and the like are known.

Approaches for improving the productivity of designing a screen have also been researched and developed. For example, an approach for efficiently designing a screen is described in Japanese Patent Laid-Open No. 4-280321, and a method for realizing screen transition independently of a standard program pattern is described in Japanese Patent Laid-Open No. 02-010430.

In recent information processing units, a build tool has been developed for generating executable files for products, debugging, and preview from the source code of an application program so that various executable files that match applications from a source code can be obtained.

The build tool has a preprocessor for executing preprocessing, a compiler for converting the source code into an object code and a linker or the like for generating an executable file by adding the required library and the like to an object code converted by the compiler.

For example, when a developed application program is to be demonstrated to a customer or the like, a specified screen of the application program can be previewed by generating an executable file for preview from the source code by using the build tool set in the preview mode and by executing the processing according to the executable file with an activation tool.

FIG. 1 is a block diagram showing an example of a combination of tools required for a conventional screen preview.

As shown in FIG. 1, information on a screen designed by a user with a screen designing tool is saved as a screen defining file (code file). The screen defining file is converted into an executable file using the build tool in the preview mode that have a build configuration for preview, and a preview screen is displayed by an activation tool according to the executable file. Here, the activation tool forms a target screen by referencing a known dll group (runtime library) as required.

Generally, the above-mentioned build tool in the preview mode does not have a function of generating a code for transiting a screen. Thus, according to the tool configuration shown in FIG. 1, only a single screen can be usually displayed for preview.

Therefore, in order to transit a screen for preview, a user needs to create an executable file from a source code by using the tool configuration shown in FIG. 2.

FIG. 2 is a block diagram showing an example of a combination of tools required for transiting a screen for preview included in a conventional screen transiting program generating device.

In order to transit a screen for preview, a user creates a screen defining file (code file) by using a screen designing tool and also creates a screen transiting information file including a definition of a previous screen and a target screen by using a screen transiting creating tool, as shown in FIG. 2. The user creates processing logic for screen transition based on a screen defining file, and then creates coded screen defining file (code file) by coding the processing logic for screen transition.

The coded screen defining file is converted into an executable file by a build tool in debugging mode with a build configuration for debug, for example, and a preview screen is displayed by an activation tool according to the executable file. Here, the activation tool reads screen transiting information file into the executable file by referencing the dll group, and transits the screen when an event occurs in response to pressing a predetermined key on a keyboard or clicking a button on a screen based on information on the screen transiting information.

That is to say, in the conventional screen transition program generating device, a screen cannot be changed when an application program is previewed only using a product obtained at the step of designing the screen. Therefore, in order to transit a preview screen, processing logic for transiting a screen needs to be created separately as shown in FIG. 2 and coded to reflect the logic in a screen defining file. That lowers the productivity in developing an application program.

### SUMMARY OF THE INVENTION

The present invention intends to provide a screen transition program generating method and device that enables screen transition in previewing while eliminating requirement of creating processing logic for screen transition or coding processing to improve the productivity of developing in application program.

In order to achieve the above-mentioned object, in the present invention, a screen transition program generating device changes a processing program that corresponds to an event included in a screen defining file into a runtime library calling program required to screen transition that corresponds to an event by referencing previously created screen transition information when a user issues an instruction to create an executable file for previewing, and generates an executable file for previewing from a screen defining file including the runtime library calling program.

Therefore, screen transition in previewing is enabled without creating or coding processing logic for screen transition. Thus, the productivity in developing an application program is improved.

The above and other objects, features, and advantages of the present invention will become apparent from the following description with reference to the accompanying drawing which illustrate example of the present invention.

### BRIEF DESCRIPTION OF THE DRAWINGS

FIG. 1 is a block diagram showing an example of combinations of tools required for previewing a conventional screen;

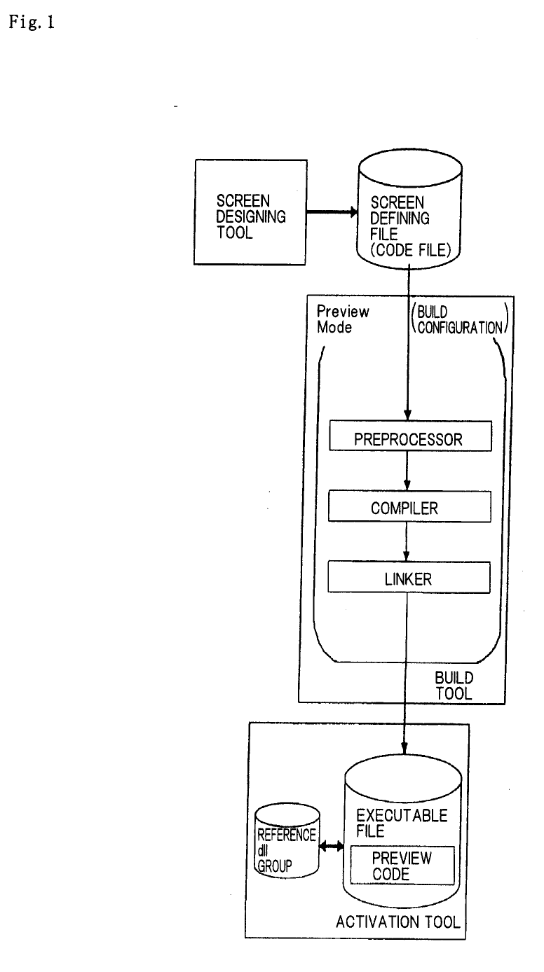

FIG. 2 is a block diagram showing an example of combinations of tools required for transiting a previewing screen included in a conventional screen transition program generating device;

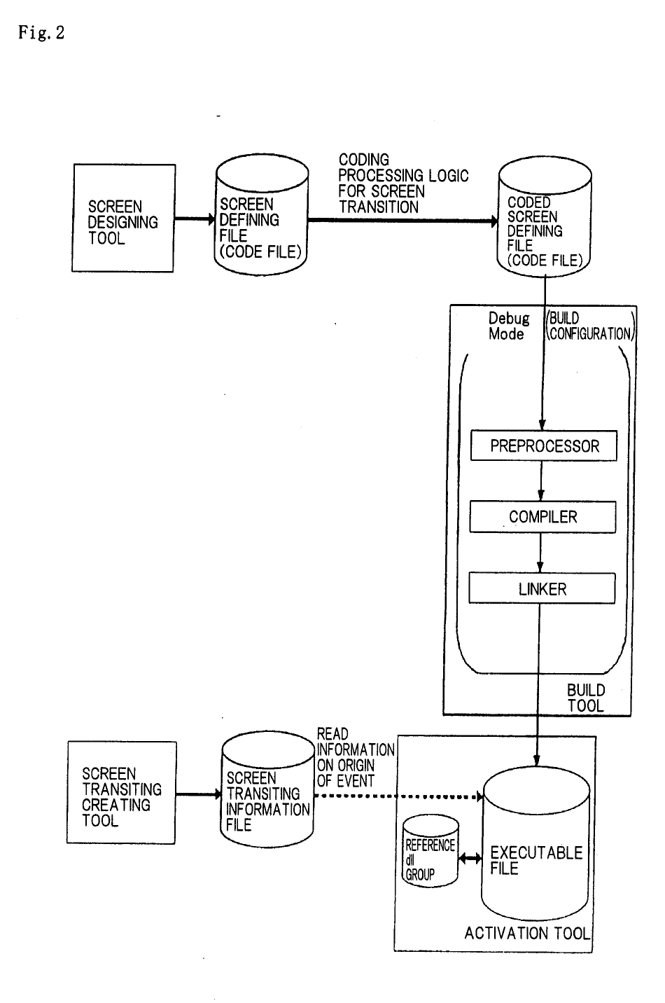

FIG. 3 is a block diagram showing an example of a configuration of the screen transition program generating device of the present invention;

FIG. 4 is a block diagram showing an example of combinations of tools required for previewing a screen included in the screen transition program generating device of the present invention;

FIG. 5 is a schematic diagram showing an example of a screen defining file shown in FIG. 4;

FIG. 6 is a schematic diagram showing an example of a screen transition file shown in FIG. 4;

FIG. 7 is a schematic diagram showing an example of a previewing screen defining file with code shown in FIG. 4; and

FIG. 8 is a flowchart showing the processing procedure of the activation tool shown in FIG. 4.

### DETAILED DESCRIPTION OF THE PREFERRED EMBODIMENTS

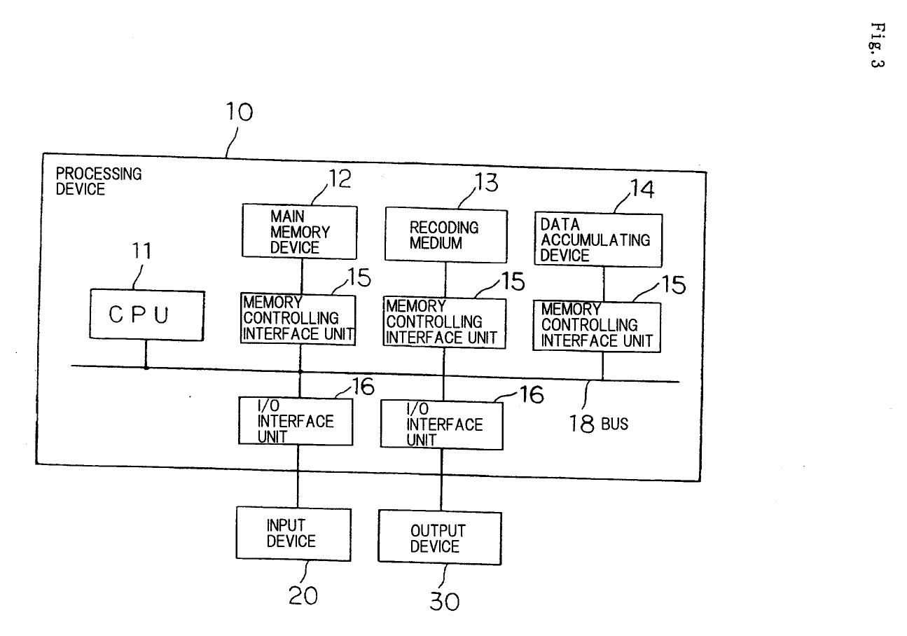

As shown in FIG. 3, the screen transition program generating device of the present invention is an information processing unit such as a computer and includes processing device 10 for executing a predetermined process according to a program, input device 20 for inputting a command, information or the like in processing device 10, and output device 30 for monitoring the processing result of processing device 10. Input device 20 is a keyboard or a mouse, for example, and output device 30 is a memory device such as a display device, a printer or the like.

Processing device 10 includes CPU 11, main memory device 12 for temporally storing information required for processing by CPU 11, recording medium 13 for recording a program for causing CPU 11 to execute various types of processing operations of the present invention, data accumulating device 14 for storing various files required for designing a screen and transiting a screen, main memory device 12, memory controlling interface unit 15 for controlling data transition with recording medium 13 and data accumulating device 14, and I/O interface unit 16 as an interface unit for input device 20 and output device 30. CPU 11 is connected with the memory controlling interface unit 15 and the I/O interface unit 16 via a bus 18. Processing device 10 may include a communication controlling device that is an interface for connecting with a network. Data accumulating device 14 is not necessarily included in processing device 10 and may be separately included outside the processing device.

Processing device 10 executes processing as a screen designing tool, a screen transition creating tool, an activation tool, a build tool and a preview code inserting tool according to a program recorded in recording medium 13. Recording medium 13 may be a magnetic disk, a semiconductor memory, an optical disk or other recording medium.

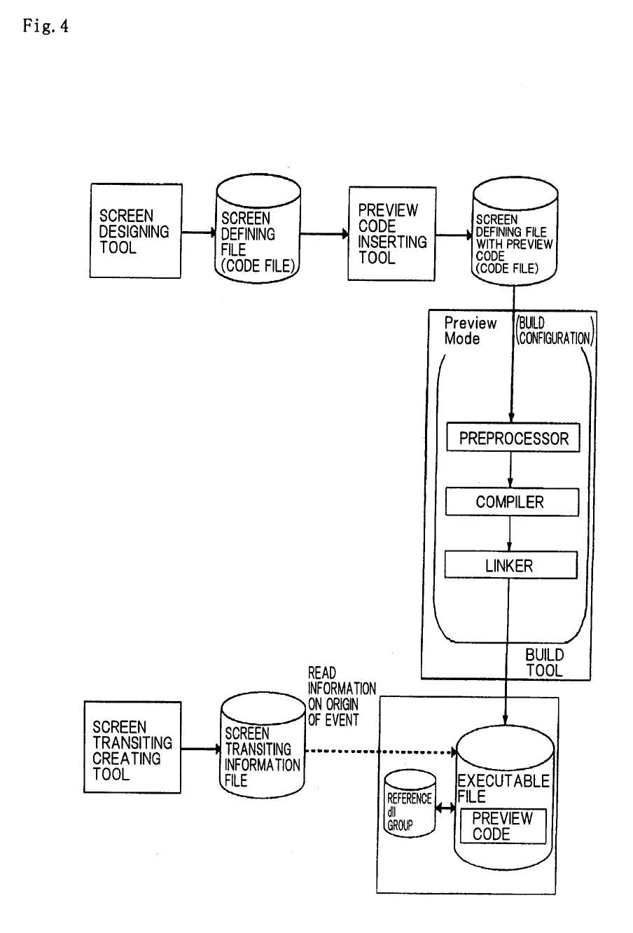

As shown in FIG. 4, the screen transition program generating device according to the present invention is adapted to include a screen designing tool, a screen transition creating tool, an activation tool, a build tool and a preview code inserting tool.

The preview code inserting tool inserts a preview code into a screen defining file (code file) of an application program created by a user using a screen designing tool. Thus, in the present invention, a preview code is included in the built executable file.

The preview code is a calling program for calling a runtime library (reference dll group) required to transit between screens that correspond to an occurring event by referencing a previously created screen transition information file.

When instructed to create an executable file for preview, the preview code inserting tool searches for a processing program part that correspond to an event from the screen defining file and changes the processing program part corresponding to the found event into a preview code that correspond to the event.

In the present invention, a screen defining file with preview code (code file) including a preview code is built by a build tool in a preview mode with a build configuration for preview and converts it into an executable file including a preview code.

When an event occurs as a user presses down a predetermined key on the keyboard or clicks a button on a screen while previewing the screen, the activation tool reads information on a key code or a button control (origin of event occurrence) from a previously generated screen transition information file based on a preview code included in the executable file. Since the screen class names of the origin of the event occurrence and a previous screen and the screen class name of a target screen are associated with each other and defined in the screen transition information file, the activation tool reads a required runtime library (reference dll group) according to screen transition information read out from the screen transition information file and switches the current screen to the target screen displayed on the output device (display device). Therefore, in the information processing unit according to the present invention, a preview screen can be transited even if the user does not execute coding processing by creating processing logic for screen transition.

The screen designing tool and the screen transition creating tool include well-known functions just as conventional tools do. Since the functions do not directly relate to the present invention, they are omitted from the detailed description here.

Data accumulating device 14 stores a screen defining file created by using a screen designing tool, a screen defining file having a preview load in which a preview code is inserted by the preview code inserting tool, an executable file created by a screen transition information file and a build tool created by using a screen transition creating tool and a runtime library (reference dll group).

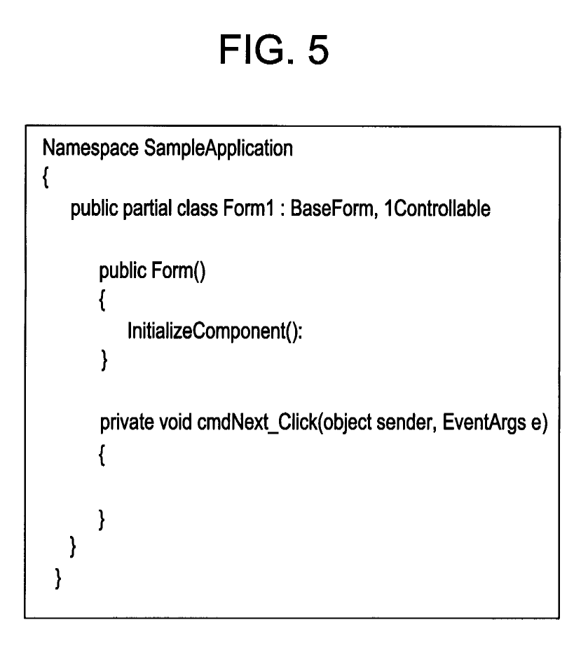

In the screen defining file (code file), the definition of an event handler the corresponds to a control (button, text box or the like) to be arranged on a screen, for example, has been previously described as shown in FIG. 5.

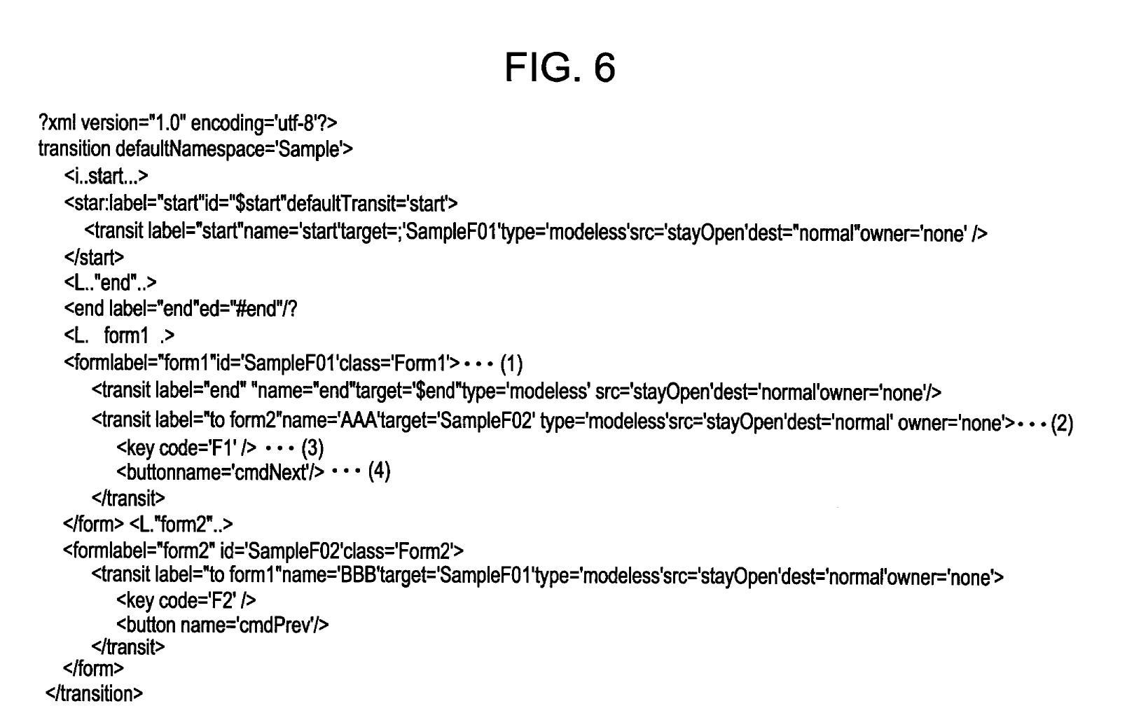

In the screen transition information file, (1) a definition of a screen class, (2) a definition of a screen transition for each screen class, (3) a key code name for implementing screen transition in response to pressing down a key and (4) a button control name for implementing screen transition in response to pressing down a key are previously described as shown in FIG. 6. (3) and (4) in FIG. 6 are examples where a screen transition defined in (2) is implemented when an event occurs.

FIG. 6 shows an example where each screen class is defined by <form> tag and a screen class name is defined in the class attribute. FIG. 6 also shows an example where the previous screen of each screen class is defined by <transit> tag in the corresponding <form> section. FIG. 6 shows an example in which a key code name for transiting a screen is defined in response to the pressing action by the <key> tag in the corresponding <form> section, and a button control name for transiting a screen is defined in response to the pressing action by <button> tag in the <transit> section.

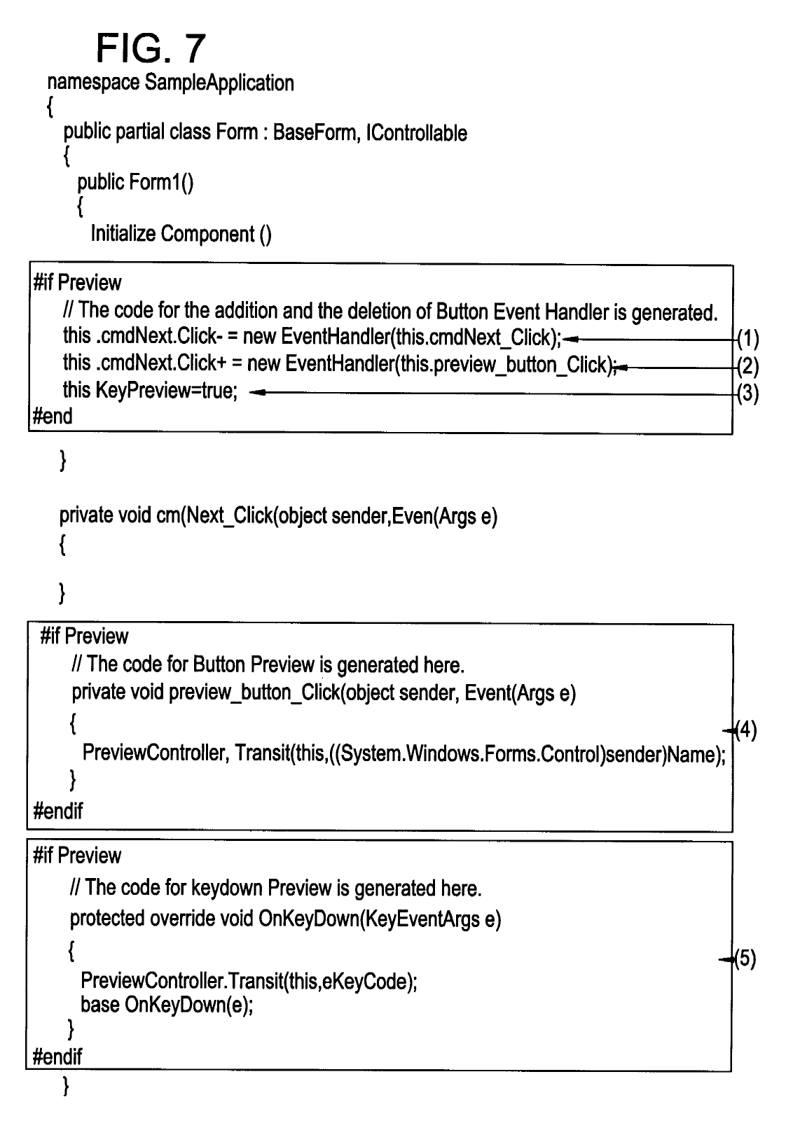

In the screen defining file with a preview code (code file), constructor processing that is enabled only during the preview and the definition of an event handler are described. FIG. 7 shows an example where a preview code is inserted in the screen defining file shown in FIG. 5.

As shown in FIG. 7, the preview code inserting tool implements the processes below on the screen defining file:

(1) to delete an existing event handler that is defined in response to a button pressing event (click event);

(2) to add a common event handler for preview in response to the button pressing event (click event);

(3) to set the KeyPreview property of a screen class as “true”;

(4) to insert a definition of a preview common event handler is called in response to pressing the button; and

(5) to insert the definition of an event handler is called when a key pressing event (key down event) occurs.

Although an example where a screen designing tool, a screen transition creating tool, an activation tool, a build tool and a preview code inserting tool are included in one information processing unit is described in the above description, all the tools need not be included in one information processing unit and may be included in a plurality of information processing units as distributed. The screen transition program generating device of the present invention is generally implemented by a computer, but the activation tools are not limited to computers and may be implemented in a PDA (Personal Digital Assistants), a mobile phone or the like.

Although an example where each function of the screen designing tool, the screen transition creating tool, the activation tool, the build tool and the preview code inserting tool included in the screen transition program generating device is implemented by a program in the above description, the function of each of the tools may be implemented by a memory or by LSI formed by a logical circuit.

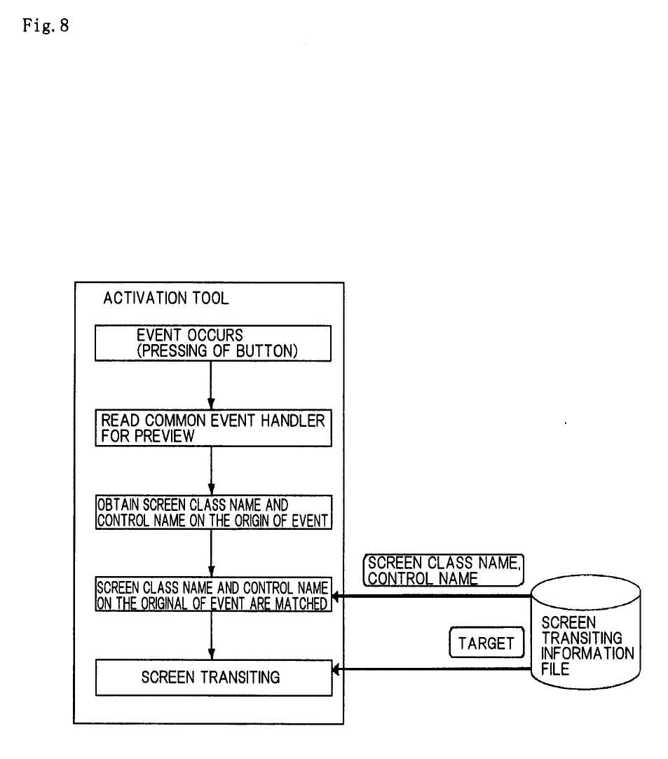

Now, operations of the screen transition program generating the device of the present invention will be described with reference to FIGS. 4 and 8.

FIG. 8 is a flowchart showing a processing procedure of the activation tool shown in FIG. 4.

As shown in FIG. 4, a user creates a screen defining file (code file) with a screen designing tool in advance and also creates a screen transition information file including a definition of a previous screen or a target screen by using the screen transition creating tool.

Processing device 10 activates the preview code inserting tool according to an instruction input by a user and generates a screen defining file with a preview code (code file) by inserting a preview code into a screen defining file.

As the screen defining file with a preview code is converted into an executable file by the build tool in a preview mode with a build configuration for preview, as mentioned above, a screen for preview is displayed by the activation tool according to the executable file.

As shown in FIG. 8, when the screen is previewed, processing device 10 activates the activation tool and monitors whether an event has occurred in response to pressing the button. When the event occurs, a common event handler for preview is read from the executable file, and the current screen class name and the control name at the origin of the event are obtained according to the method defined in the common event handler for preview.

Next, processing device 10 reads the screen transition information file, determines whether the button name or the key code name that are the same as the control name at the origin of the event is defined in the definition of screen transition that corresponds to the obtained current screen class, and if the same control name is defined, the screen is transited according to the screen class name at the target screen (information on the target screen) defined in the screen transition information file. At this time, the activation tool forms a screen at the target screen by referencing the runtime library (see dll group) according to screen transition information.

According to the present invention, when instructed to create an executable file for preview, a processing program corresponding to an event included in the screen defining file is changed into a runtime library calling program required to transit between screens that correspond to an event by referencing the screen transition information created in advance, and an executable file for preview is generated from the screen defining file including a runtime library calling program. For this purpose, screen transition in the preview is enabled without creating processing logic for screen transition or coding processing. Therefore, the productivity in developing an application program is improved.

While preferred embodiments of the present invention have been described using specific terms, such description is for illustrative purposes only, and it is to be understood that changes and variations may be made without departing from the spirit or scope of the following claims.

What is claimed is:

1. A screen transition program generating method for generating a screen transition executable file for transiting between a plurality of screens in response to an event, comprising the steps of:
wherein, when instructed to create said executable file for preview,
searching a processing program corresponding to said event in a screen defining file, which is source code to define said screen,
changing a processing program corresponding to said searched event into a runtime library calling program required for said transition between screens that correspond to said event by referencing screen transition information that defines a relationship between said previously created event and said transition between screens, and
generating said executable file for preview from the screen defining file including said runtime library calling program.

2. The screen transition program generating method according to claim 1, wherein the screen defining file including said runtime library calling program is built according to a building program including a build configuration for preview, and said executable file for preview is generated.

3. The screen transition program generating method according to claim 1, wherein a processing program according to a method:
deletes an existing event handler defined in response to said event;
adds a common event handler for preview corresponding to said event;
sets KeyPreview property of the screen class to “true”;
inserts a definition of a common event handler for preview that is called when an even occurs; and
inserts a definition of an event handler that is called an event occurs, as said runtime library calling program.

4. A screen transition program generating device for generating a screen transition executable file for transiting between a plurality of screens in response to an event, comprising:
a processing device, wherein when instructed to create said executable file for preview, searches a processing program corresponding to said event in a screen defining file, which is source code to define said screen, changes a processing program corresponding to said searched event into a runtime library calling program required for said transition between screens corresponding to said event by referencing screen transition information that defines a relationship between said previously created event and said transition between screens, and generates said executable file for preview from the screen defining file including said runtime library calling program; and
a data accumulation device in which said screen defining file, said screen transition information, said runtime library and said preview executable file are stored.

5. The screen transition program generating device according to claim 4, wherein the processing device builds the screen defining file including said runtime library calling program according to a building program including a build configuration for preview, and generates said preview executable file.

6. The screen transition program generating device according to claim 4, wherein said processing device
deletes an existing event handler defined in response to said event;
adds a common event handler for preview corresponding to said event;
sets KeyPreview property of the screen class to “true”;
inserts a definition of a common event handler for preview that is called when an even occurs; and
inserts a definition of an event handler that is called when an event occurs, as said runtime library calling program.

7. A computer readable recording medium storing a program for causing a computer to generate a screen transition executable file for transiting between a plurality of screens in response to an event, wherein said program causes a computer to execute the processes of:
searching a processing program corresponding to said event in a screens defining file, which is a source code to define said screen, when it is instructed to create said executable file for preview,
changing a processing program corresponding to said searched event into a runtime library calling program required for said transition between screens corresponding to said event by referencing screen transition information that defines a relationship between said previously created event and said transition between screens, and
generating said executable file for preview from the screen defining file including said runtime library calling program.

8. The computer readable recording medium according to claim 7, wherein said program causes the computer to execute the processes of building the screen defining file including said runtime library calling program according to a building program including a build configuration for preview, and generating said preview executable file.

9. The computer readable recording medium according to claim 7, wherein said program causes the computer to execute the processes of:
deleting an existing event handler defined in response to said event;
adding a common event handler for preview corresponding to said event;
setting KeyPreview property of the screen class to “true”;
inserting a definition of a common event handler for preview that is called when an even occurs; and
inserting a definition of an event handler that is called when an event occurs, as said runtime library calling program.
